(19) United States
(12) Patent Application Publication
(10) Pub. No.: US 2024/0144213 A1
(43) Pub. Date: May 2, 2024

(54) SYSTEM AND METHOD FOR AUTOMATIC ROUTING OF WAGES

(71) Applicant: ActiveHours, Inc., Palo Alto, CA (US)

(72) Inventor: Ramanathan Palaniappan, Palo Alto, CA (US)

(21) Appl. No.: 18/500,067

(22) Filed: Nov. 1, 2023

Related U.S. Application Data
(60) Provisional application No. 63/421,518, filed on Nov. 1, 2022.
(60) Provisional application No. 63/421,519, filed on Nov. 1, 2022.
(60) Provisional application No. 63/421,515, filed on Nov. 1, 2022.

(51) Int. Cl. G06Q 20/10; G06Q 20/40

(52) U.S. Cl. CPC G06Q 20/108; G06Q 20/4016

(57) ABSTRACT

Described herein, in some aspects, are systems and methods for allowing employees (e.g., workers) to access and use money earned but not yet paid by the employee's employer. Such earnings may be used to pay bills, purchase goods and services, and otherwise enjoy their unpaid wages prior to the end of a pay period and before their employer has released the funds (e.g., funds for the wages). In some embodiments, the systems and methods described herein provide safeguards to help mitigate a risk of not recovering wages disbursed in advance to an employee who may have an unstable employment and/or unpredictable income. In some embodiments, the system is configured to automatically partition wages received for a pay period to reconcile advanced wages received and route a desired amount of wages to one or more different financial accounts.

### CROSS-REFERENCE

This application claims the benefit of and priority to U.S. Patent Application No. 63/421,518, titled “System and Method for Providing Advance Access to Unpaid Wages”, and filed Nov. 1, 2022; to U.S. Patent Application No. 63/421,519, titled “System and Method for Accessing Unpaid Wages”, and filed Nov. 1, 2022; and to U.S. Patent Application No. 63/421,515, titled “System and Method for Automatic Routing of Wages”, and filed Nov. 1, 2022; each of which is incorporated herein by reference in its entirety.

### BACKGROUND

Conventional employment relationships operate on an accrued wages model in which workers perform their jobs, record their time and/or attendance (in some instances), and after some period of time are paid wages for a preceding pay period. While many workers have adequate funds to pay their monthly expenses, due to infrequent expenses such as a vacation, unexpected medical expenses or even unexpected outlays such as car repairs, many workers either live paycheck to paycheck, or simply need additional funds temporarily to cover unanticipated costs. In most cases, consumers may resort to credit cards, which have high fees and interest rates, friends and family (which may or may not be available or practical), bank overdraft, pawn shops or even short-term loans such as payday loans or the like, which often have high fees and interest rates. All the while, the employer essentially “owes” the employee a certain portion of their wages for work performed, but because the end of the pay period has not yet arrived, the employee cannot access or use these owed monies. What is needed, therefore, are techniques and supporting systems that facilitate early access to earned and accrued wages in an efficient and cost-effective manner, while maintaining flexibility with disbursing actual wages received with a paycheck.

### SUMMARY

Disclosed herein, in some aspects, is a system for automatically partitioning and transferring scheduled wages based on advanced wages disbursed for a pay period prior to receiving the scheduled wages, the system comprising one or more processors; and one or more memories storing instructions that, when executed by the one or more processors, cause the system to perform operations including: identifying a predictable pattern for i) the amount of scheduled wages received by the employee, ii) the frequency of the scheduled wages received, iii) a rate at which the scheduled wages are accrued during the pay period (“pay rate”), or iv) a combination thereof; receiving, from the employee, input relating to a desired amount of advanced wages to be transferred to a financial account associated with the employee (“employee account”); calculating a distribution of the scheduled wages based on i) the predictable pattern amount of scheduled wages, ii) the advanced wages disbursed to the employee during the pay period, iii) outstanding advanced wages from a previous pay period, iv) the desired amount of advanced wages to be transferred, or v) a combination thereof, wherein the one or more processors is configured to determine an available transfer amount that is less than or equal to the desired amount; and automatically transferring the available transfer amount to the employee account from a financial account associated with the system (“system account”), wherein the system account is configured to receive the scheduled wages; wherein any one of the one or more processors is configured to be in communication with the employee account, the system account, or both, so as to perform operations from one or more of (a)-(d).

Disclosed herein, in other aspects, is a non-transitory computer readable medium for disbursing advanced wages to an employee prior to a payment date of scheduled wages for a pay period, the non-transitory computer readable medium comprising instructions that, when executed by a processor, cause the processor to perform operations including: identifying a predictable pattern for i) the amount of scheduled wages received by the employee, ii) the frequency of the scheduled wages received, iii) a rate at which the scheduled wages are accrued during the pay period (“pay rate”), or iv) a combination thereof; receiving, from the employee, input relating to a desired amount of advanced wages to be transferred to a financial account associated with the employee (“employee account”); calculating a distribution of the scheduled wages based on i) the predictable pattern amount of scheduled wages, ii) the advanced wages disbursed to the employee during the pay period, iii) outstanding advanced wages from a previous pay period, iv) the desired amount of advanced wages to be transferred, or v) a combination thereof, wherein the processor is configured to determine an available transfer amount that is less than or equal to the desired amount; and automatically transferring the available transfer amount to the employee account from a financial account associated with a system (“system account”), wherein the system account is configured to receive the scheduled wages; wherein any one of the processor is configured to be in communication with the employee account, the system account, or both, so as to perform operations from one or more of (a)-(d).

Disclosed here, in other aspects, is a method for disbursing advanced wages to an employee prior to a payment date of scheduled wages for a pay period, the method comprising: identifying a predictable pattern for i) the amount of scheduled wages received by the employee, ii) the frequency of the scheduled wages received, iii) a rate at which the scheduled wages are accrued during the pay period (“pay rate”), or iv) a combination thereof; receiving, from the employee, input relating to a desired amount of advanced wages to be transferred to a financial account associated with the employee (“employee account”); calculating a distribution of the scheduled wages based on i) the predictable pattern amount of scheduled wages, ii) the advanced wages disbursed to the employee during the pay period, iii) outstanding advanced wages from a previous pay period, iv) the desired amount of advanced wages to be transferred, or v) a combination thereof, wherein an available transfer amount that is less than or equal to the desired amount is determined; and automatically transferring the available transfer amount to the employee account from a financial account associated with a system (“system account”), wherein the system account is configured to receive the scheduled wages.

### BRIEF DESCRIPTION OF THE DRAWINGS

These and other features, aspects, and advantages of some embodiments will become better understood with regard to the following description and accompanying drawings.

FIG. 1A depicts a block diagram of the Earnings tool, according to an embodiment described herein.

FIG. 1B depicts an exemplary display of the system, according to an embodiment described herein.

FIG. 1C depicts another exemplary display of the system, according to an embodiment described herein.

FIG. 2 depicts an exemplary input display for a user to enter wage routing information, according to an embodiment described herein.

FIG. 3 depicts an exemplary flow chart of the Routing module operation, according to an embodiment described herein.

FIG. 4 depicts an exemplary computer system, in accordance with an embodiment.

FIGS. 5A-5C depict examples for available earnings based on payment of wages in relation to the pay period, according to one or more embodiments herein.

FIG. 6A depicts a graphical representation of parameters used by a machine learning model to predict employment status, according to an embodiment described herein.

FIG. 6B depicts a table outputting parameters used by the machine learning model in FIG. 6A, according to an embodiment described herein.

FIG. 7 depicts an example for partial routing of wages, according to an embodiment described herein.

### DETAILED DESCRIPTION

I. Definitions

Terms used in the claims and specification are defined as set forth below unless otherwise specified.

The term “employee”, as used herein, refers to a person that is employed and receives wages from an employer. The term “employee” and “worker” may be used interchangeably herein.

The term “earnings” refers to unpaid wages for time worked by the employee.

The term “funds”, as used herein refers to a monetary value, corresponding to any currency, such as U.S. Dollars, Canadian Dollar, Euro, and any Cryptocurrency.

The term “wages”, as used herein, refers to payment received for time worked by the employee.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of,” “only one of,” or “exactly one of.”

II. System Overview

Described herein, in some embodiments, are systems and methods for automatically routing at least a portion of an employee's wages to an external account at a financial institution (e.g., an external bank account from the system), while allowing an employee to access wages earned through employment but not yet paid or received. As used herein, the term “earnings” refers to said unpaid wages. In some embodiments, the system is configured to receive input from a user (e.g., an employee) for a desired amount to be routed. In some embodiments, the system is configured to determine an amount of wages available to be transferred based on earnings accessed by the user (i.e., unpaid wages accessed during the pay period), as described herein. In some embodiments, the system is configured to determine a maximum amount of the wages that can be used by a credit card (e.g., Earning Card, as described herein) in view of the desired amount of wages to be routed.

In some embodiments, said earnings correlate with employment during a given pay period, wherein said earnings for the given pay period correspond to the wages for the given pay period. In some embodiments, said earnings are accumulated throughout the pay period, for example hourly, daily, every other day, weekly, etc. As a result, systems and methods described herein allow employees (e.g., workers) to access and use money earned but not yet paid (i.e., earnings) by the employee's employer. Such earnings may be used to pay bills, purchase goods and services, and otherwise enjoy their unpaid wages prior to the end of a pay period and before their employer has released the funds (e.g., for the wages). Additional intended uses of the invention can include avoiding overdraft fees and avoiding carrying a balance on a credit card. These earnings may be transferred to the employee, who may withdraw it as cash or use it as digital currency or virtual goods within an electronic marketplace.

In some embodiments, as described herein, the system is configured to predict the amount of wages received by the employee for a given pay cycle and/or the frequency of receiving said wages, wherein said wages paid by an employer for a given pay cycle (or pay period) may be referred to herein as scheduled wages. In some embodiments, as described herein, the scheduled wages are paid on a payment date of a pay cycle. In some embodiments, as described herein, the system is configured to verify the employment status of the employee during the pay period, thereby allowing the earnings corresponding to the unpaid wages for the time worked (during the given pay period) to be accessible to the employee. In some embodiments, the employment status is automatically verified. In some embodiments, an employment status correlates to continued employment by the employee and/or changes that may impact employment stability. In some embodiments, the employment status is verified through one or more employment verifiers, which may comprise work email status, global positioning system (GPS) location identifiers, payroll active status, an employee risk score, previous restore and/or restore failure records (as described herein), timesheet, user income stability type, employment status prediction using a machine learning model, or any combination thereof.

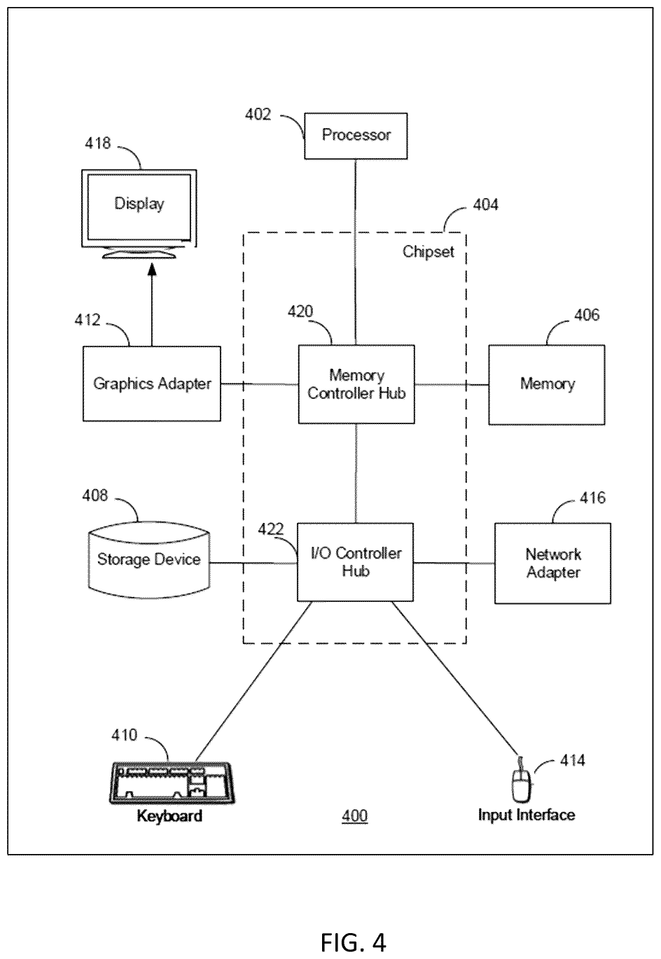

In some embodiments, the system comprises one or more computing devices, and one or more components of a network and/or server, for example as described herein in FIG. 4, which may be remote from the employee. In some embodiments, the system is configured to interface with the employee via a software application, e.g., an “app” which may be accessed through a computing device. For example, in some cases the employee can use a mobile device, such as a smart device (e.g., smartphone, tablet, smart watch), to access the system.

In some embodiments, the system is configured to function similar to that of a financial institution (e.g., a bank). For example, in some embodiments, the system functions, at least in part, similar to that of a checking account at a bank. In some cases, the system however updates an earnings balance in said similar “checking account”, so as to provide an employee with access to said earnings in advance of a pay date (or pay cycle). In some cases, such earnings balance is updated frequently (e.g., hourly, daily, in real-time) as time is worked and in advance of a pay date for the wages. Accordingly, in some cases, the system is configured to assign a profile for the employee that is specific to the employee's information, such as earnings available, employment status, etc. In some embodiments, a system described herein is configured to receive and/or disburse funds (e.g., any type of currency, such as U.S. Dollar, Euro, Canadian Dollar, Cryptocurrency, etc.). In some embodiments, the system is configured to function similar to that of the remote processing device and/or remote server described in U.S. Pat. No. 9,202,250, the entirety of which is incorporated herein by reference. In some embodiments, funds are configured to be transferred to the system, for example, to the profile associated with the employee (e.g., funds may be transferred by another financial institution, the employee, or other third party). In some embodiments, funds are configured to be direct deposited to the system from, for example, an employer wage disbursement system. In some embodiments, funds are configured to transferred out by the employee, to, for example, a financial institution, a merchant, another individual, etc. In some embodiments, the employee is able to access funds from the system using a monetary dispensing apparatus (e.g., ATM machine). In some embodiments, the employee is able to access funds using a payment card, which may act similar to that of a debit card.

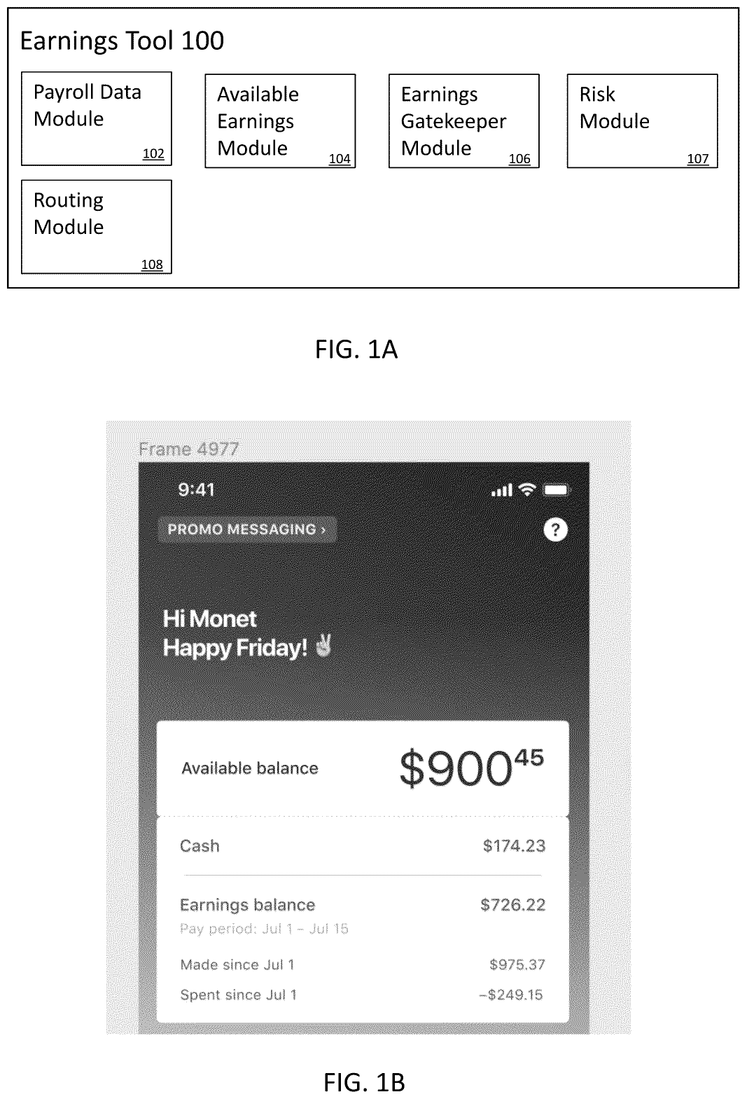

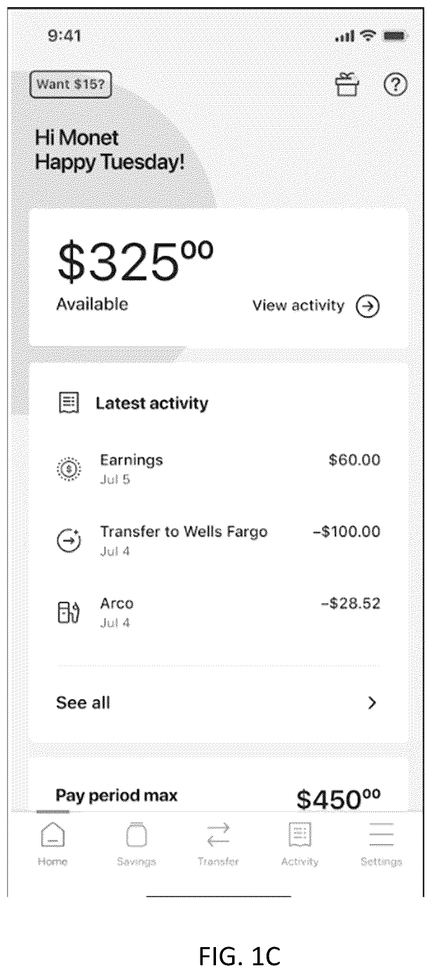

In some embodiments, FIG. 1A depicts a block diagram of exemplary computer logic components of an Earnings tool 100 used by the system for determining and enabling access to unpaid wages in a given pay period (“earnings”). In some embodiments, the exemplary computer logic components include a Payroll Data (“PD”) module 102, an Available Earnings module 104, an Earnings Gatekeeper module 106, a Risk Module 107, a Routing Module 108, or any combination thereof. In some embodiments, any such modules may be incorporated in the system as a separate tool, which may be in communication with the Earnings tool 100.

As described herein, in some embodiments, the Earnings tool 100 is configured to determine an amount of earnings accessible to the employee. In some cases, the Earnings tool accesses third party information to verify the employee has indeed worked, and thereby earned such earnings. In some cases, the Earnings tool is configured to determine the amount of earnings available, based on expenditures by the employee.

### Payroll Data (“PD”) Module

In some embodiments, the PD module 102 is configured to determine the parameters that define the amount of earnings earned by the employee during a given pay period. In some embodiments, the PD module is configured to determine the eligibility of the employee to use the system, and/or to on-board an employee with the required information.

In some embodiments, the PD module is configured to determine said eligibility of the employee based on one or more employment characteristics, such as type and/or name of employer, length of employment by the employee, frequency of wages received (e.g., pay cycle), amount of wages received, expenditures by the employee, validation of a paycheck, or any combination thereof. In some embodiments, the PD module 102 is configured to determine whether the employee receives a paycheck (e.g., regular wages) from the employer in a predictable manner. For example, in some cases the PD module is provided access to the employee's account at a financial institution (e.g., a bank, such as Bank of America, Chase, etc.), so as to review the account history to determine the amount and frequency of any direct deposits or other deposits (e.g., checks, cash) that correlate with wages from an employment. In some embodiments, the PD module determines a predictability of the wages based on a frequency of direct deposits detected in the account and an amount. In some embodiments, the PD module is configured to group transactions, so as to identify transactions that correlate with direct deposits or cash/check deposits associated with wages. In some embodiments, the PD module is configured to group multiple sets of wages if the employee has multiple employers.

For example, in some embodiments, the PD module identifies wages as being predictable from an employer if there are at least 2, 3, 5, 10, or more direct deposits detected in the account. In some cases, the PD module further determines a frequency of the direct deposits, for example weekly, bi-weekly, monthly, number of days, etc. In some cases, the PD module determines whether the amount of the direct deposits is consistent, or within a certain tolerance, such as within at most 1%, 2%, 5%, 10%, or 20% of each other. In some embodiments, the PD module correlates with a frequency of wages based on employment type. For example, in some embodiments, where the employer is the military, only one direct deposit is needed as the PD module includes stored information relating to military wage disbursements. In some cases, if the employer is listed as a preferred employer, the PD module requires only two direct deposits to confirm the wages as being predictable. In such cases, an employer may be a preferred employer based on a predetermined list of employers and/or characteristics provided by the employee.

In some embodiments, where one or more direct deposits are missing such that a pattern of wages received cannot be determined, the PD module is configured to automatically alert an agent (associated with the system), and/or request the employee upload a paystub for verification.

In some embodiments, where wages are deposited into the employee's account via cash and/or check deposits, the PD module is configured to automatically alert an agent (associated with the system), and/or request the employee to upload a plurality of paystubs, so as to determine a frequency of the wages received, and amount (as described herein).

In some embodiments, the PD module determines an hourly rate of the employee. In some embodiments, the hourly rate is based on an amount of deposits made to an account (e.g., in a financial institution) divided by the number of hours worked by the employee in the given pay period. In some embodiments, the hours worked is determined based on the length of the pay period. For example, in some cases, a weekly deposit correlates to 40 hours of time worked by the employee, whereas a bi-weekly deposit correlates to 80 hours. In some cases, the PD module correlates against a paystub to verify the hours worked. In some cases, the hourly rate correlates to the net pay in the wages received by the employee (instead of gross pay). Accordingly, in some cases, the net pay correlates to wages received after taxes and other deductions have been removed. In some embodiments, said hourly rate is used by the Available Earnings tool to determine earnings by the employee.

In some cases, the employee requires a minimum hourly rate in order to be eligible by the system for accessing earnings. In some embodiments, the minimum hourly rate is at least from about $0.1 to about $100 per hour, such as for example, from about $1 to about $50 per hour, from about $2 to about $25 per hour, from about $3 to about $15 per hour, for example at least about $3 to about $10 per hour, or about $4 per hour.

In some embodiments, the PD module determines a payment schedule for when the employee is expected to receive wages. In some embodiments, the PD module determines a correlating work schedule for a given pay period that aligns with the payment schedule. In some embodiments, the PD module is configured to receive input and/or automatically adjust for holidays, weekends, vacations, sick days, etc.

### Available Earnings (“AE”) Module

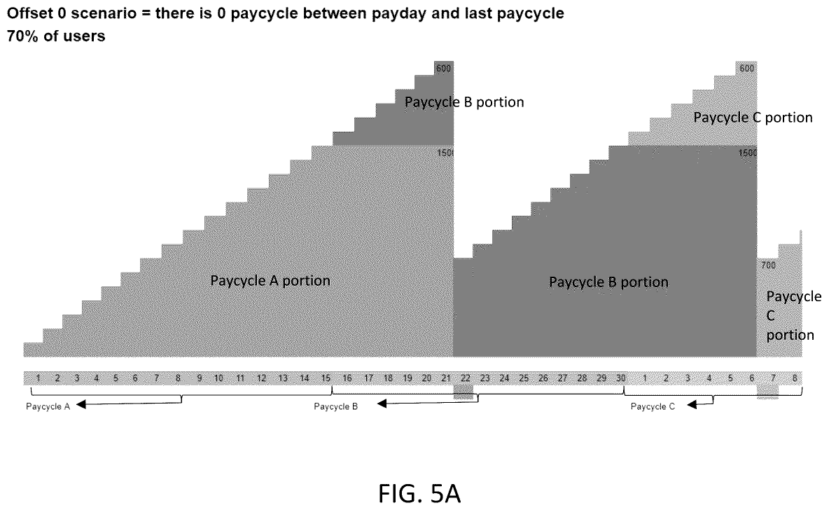

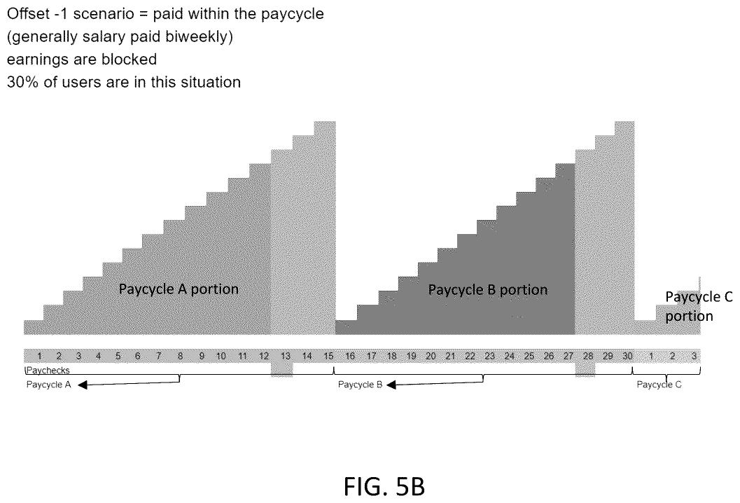

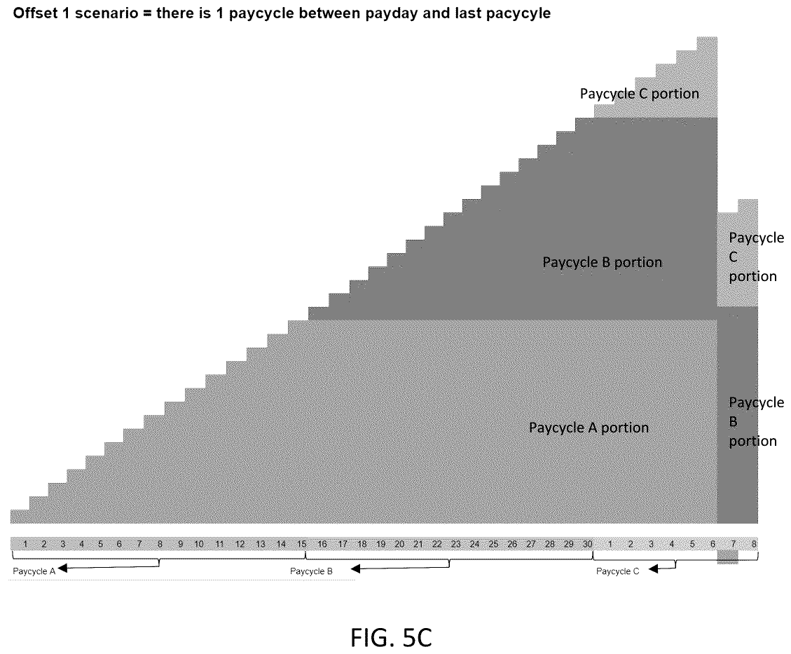

In some embodiments, the AE module 104 is configured to determine the amount of earnings available to the employee. As described herein, in some embodiments the available earnings correspond to the time worked by the employee during a given pay period (e.g., in advance of receiving the wages according to the normal pay schedule). As described below (e.g., FIGS. 5A-5C), however, in some cases the amount of earnings available may include a portion of earnings from a subsequent pay period for a period of time due to delays in when the wages are paid.

In some embodiments, the earnings available is determined based on actual earned income less any expenditures made by the employee during the pay period. In some embodiments, the actual earned income corresponds to the hours worked by the employee during a given pay period multiplied by the employee's hourly rate (as determined by the PD module for example).

In some embodiments, the earnings are accumulated according to a pre-determined frequency. For example, in some embodiments, the earnings are accumulated hourly (for each hour worked), every four hours (e.g., each half day worked), daily, every other day, weekly, every ten days, bi-weekly, monthly, etc. As described herein, the earnings are accumulated subject to clearance or “active status” per the Earnings Gatekeeper module.

In some embodiments, the expenditures correspond to funds and/or earnings withdrawn by the employee. In some embodiments, the expenditures correspond to payments made, and/or transfer of earnings to another account or individual. Accordingly, the expenditures may refer to the earnings accessed by the employee ahead of receiving the wages during the pay period. In some embodiments, the earnings are disbursed to the employee via a financial account associated with the system (e.g., “system account”, as described herein). In some embodiments, the system account essentially provides the funds associated with the system as the earnings, which may be withdrawn by the employee, transferred to another financial account associated with the employee, etc. In some embodiments, the AE module restricts the amount of expenditures allowed by the employee with respect to the earnings (e.g., restricts the accessible earnings). For example, in some cases, the AE module restricts the allowable expenditure of the earnings to a percentage amount of the total wages predicted to be received. In some embodiments, the AE module restricts the expenditure of the earnings to at most about 5%, 10%, 25%, 50%, 75%, 80%, 90% or 100% of the wages expected to be received (as predicted using the PD module for example). In some embodiments, the AE module restricts the expenditure of the earnings to a particular currency amount. For example, in some embodiments the AE module restricts the expenditure of the earnings to at most about $100 (U.S. dollar), $250, $500, $1,000, $2,000, $5,000, or $10,000. In some embodiments, the AE module restricts the expenditure of the earnings using a combination of a percentage of the total wages predicted and a currency amount. For example, in some embodiments, the AE module restricts the expenditure of the earnings from about 50% to about 90% of the total wages predicted, up to a maximum of from about $500 to about $2,000.

In some embodiments, as described herein, the system may be interfaced with the employee using a computing device (e.g., the system may be provided as an “app” on a mobile device). FIGS. 1B and 1C depict exemplary output displays of the system. In the display depicted in FIG. 1B, the earnings balance is displayed for the pay period from July 1 to July 15. As depicted, the actual earned income from July 1 is $975.37, whereas the expenditures amount to $249.15, thereby providing an available earnings of $726.22. In the display depicted in FIG. 1C, the earnings obtained for a given day (e.g., advanced wages earned for a given day) are depicted for July 5, which is $60. As further depicted, an amount of funds transferred to an external account is depicted (which may be via an automatic routing). Further, a maximum pay period wages is depicted as $450.

In some embodiments, as described herein, the system may also include other funds (e.g., any currency or monetary value, such as U.S. Dollar), which is separate from the earnings. In some cases, where the wages are directly deposited or otherwise transferred to the system (e.g., to a profile associated with the employee), after the wages have been received for a given pay period, the available earnings are converted to the funds amount (e.g., “cash” as depicted in FIG. 1B). In some embodiments, such funds are always accessible to the employee. For example, in some embodiments, access and withdrawal of such funds (e.g., “cash” in FIG. 1B) are not restricted to being cleared by the Earnings Gatekeeper module (as described herein). Accordingly, in some cases, the total available amount of currency or money available to the employee is the sum of the funds available (e.g., “cash” in FIG. 1B) and the earnings balance (e.g., $900.45 in FIG. 1B, and/or $325 in FIG. 1C). In some cases, as described herein, the AE module places limitations on the amount of earnings that is accessible (e.g., percentage of total wages predicted and/or a maximum amount), such that the total available amount of currency or money available includes only the maximum amount of earnings available.

In some embodiments, where wages are deposited into an account for another financial institution, the AE module is configured to reconcile the expenditures of the earnings (during the pay period) by automatically withdrawing the expenditure amount from the financial institution account. In other cases, for example where wages are directly deposited into the system (e.g., into an account associated with the system (“system account”)), the amount of the expenditures are automatically deducted from the wages, and the remaining is added to the funds available (e.g., “cash” in FIG. 1B).

As described herein, in some embodiments, the earnings available is based on unpaid wages for time worked by the employee. Accordingly, earnings available may be presented to the employee according to pay period, wherein in some cases, once wages for a given pay (e.g., pay cycle) period is received, the earnings available will then reflect the next pay period. In some embodiments, depending on when the wages are actually received by the employee, there may be an overlap in the earnings available between one pay period and the next pay period. Accordingly, in some cases, there may be an offset of when a pay period ends, and when the wages are actually paid. FIGS. 5A-5C depict three exemplary cases of how the earnings available transition from one pay period to the next. FIG. 5A depicts three pay cycles, pay cycle A, B, and C, each lasting 15 days, wherein available earnings are accumulated daily. As depicted in FIG. 5A, although pay cycle A ends on day 15, the wages are only paid on day 22. Thus, days 16 to 21 will include the available earnings from pay cycle A as well as a portion of pay cycle B. Once the wages are received on day 22, the available earnings for pay cycle A will be removed, and only the available earnings for pay cycle B will remain until day 30. This is an example of an Offset 0 scenario, because there are no pay cycles (e.g., pay period) between the pay cycle ending and the user getting paid for the work in that pay cycle.

FIG. 5B depicts the same three pay cycles, but payment for each pay period occurs within the pay period itself. Accordingly, although the pay period for pay cycle A is from days 1 to 15, since payment of the wages was received on day 12, there are no earnings available on days 13 to 15 since there are no unpaid wages during those days. This would be an offset of −1.

FIG. 5C depicts the same three pay cycles, but payment for each pay period occurs in the pay cycle after the subsequent pay cycle from the current pay period. Accordingly, although the pay period for pay cycle A is from days 1 to 15, the user is only paid in pay cycle C, which is after pay cycle B. Accordingly, from days 1 to 7 in pay cycle C, the user has earnings accumulated from pay cycle A, B, and 7 days in pay cycle C. This would be an offset of +1.

As described herein, in some embodiments the system functions similar, in some aspects, to a checking account, wherein instead of waiting every pay cycle to access funds, the earnings balance is updated in advance of the pay cycle. In some case, the earnings balance is updated in real-time, hourly, daily, every other day, weekly, etc. for time worked, wherein these earnings may accessed and used for expenditures (as described herein, including for example cash withdrawal, purchasing items digitally, purchasing items at a store, making payments, transferring to another person or account, etc.).

### Earnings Gatekeeper (“EG”) Module

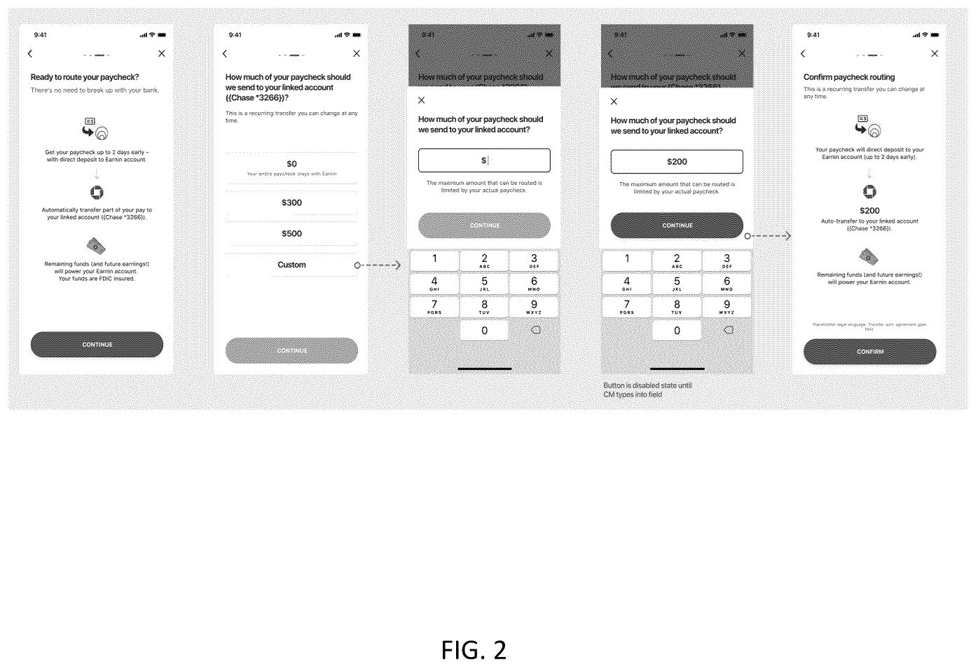

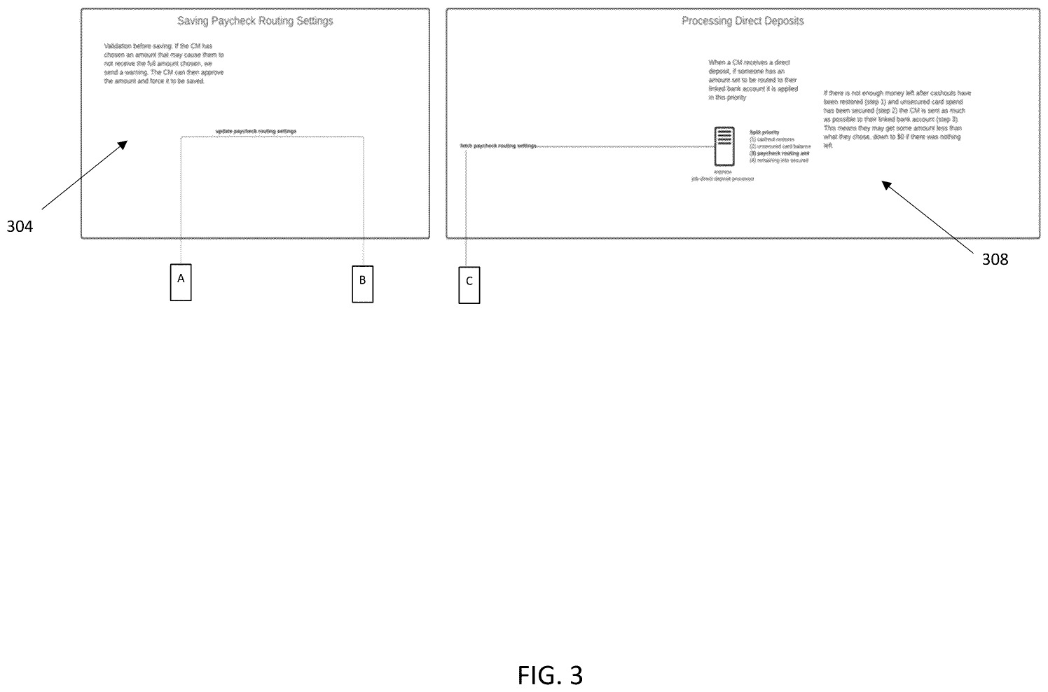

In some embodiments, the EG module 106 is configured to determine whether the employee is allowed to access the accumulated earnings during a given pay period. In some embodiments, the EG module must first determine whether the employee has an active employment before such accumulated earnings are determined. Accordingly, the earnings reported in FIG. 2 by the AE module is subject to any restrictions placed by the EG module.

In some embodiments, the EG module is configured to verify an employment status during a pay period, so as to determine whether the employee has an active status (corresponding with an employment being verified) and is thereby allowed to access earnings (either currently available earnings, or future earnings). In some embodiments, the EG module is configured to verify an employments status of a user based on a work email status (e.g. work email verification, “WEV”), a location of the employee (e.g., via global positioning system (GPS) location identifiers), payroll active status, an employee risk score, previous restore and/or restore failure records (as described herein), timesheet, user income stability type, employment status prediction using a machine learning algorithm, or any combination thereof.

In some embodiments, the PD module is configured to determine whether the employee has an “active status” (and/or “inactive status”) based on a location of the employee, and whether it correlates with a location for the employment (e.g., using GPS coordinates of the employee, employment location, predetermined geofence, etc.). In some embodiments, the location of the employee is determined via a location monitoring software. In some embodiments, the location is obtained using a computing device of the employee, such as a mobile device (e.g., smart device, smart phone, smart watch, etc.). In some cases, an employment key card is used to track when the employee enters and/or exits an employment facility. As described herein, in some cases, the EG module is configured to determine how long the employee was located at the location associated with the employment. For example, in some cases, the location of the employee may use a geofence to indicate an area of employment, and where the time and duration the employee entered an employment location and stayed there is accessible. Accordingly, as described herein, in some cases, the EG module is configured to restrict the amount of available earnings based on the number of hours the employee was located at an employment location, and/or send an alert (e.g., to the employee and/or a personnel associated with the system) for verification of hours worked (e.g., for that day).

In some embodiments, such active status (and/or “inactive status”) is determined based on use of an employment email, as described herein. For example, in some cases, the ES module will send an email with a verification link for the employee to click so as to verify employment status. In some cases, the employee is required to send an email to a prescribed email address to verify employment status. In some cases, such verification via email is required by the EG module, and via the ES module to be made hourly, daily, every other day, etc. If the employee fails to verify employment status, the EG module may restrict the available earnings (e.g., for that day). The EG module may also send an alert to the employee and/or other personnel to confirm employment status.

In some embodiments, as described herein, the Earnings tool is provided by one or more computing devices, wherein the Earnings tool can be embodied as a computer system (e.g., see FIG. 4, reference character 400). In some embodiments, the EG module confirms an active status using one or more decision engines (e.g., trained models, decision trees, analytical expressions, etc.), which may apply an algorithm (e.g., a machine learning (“ML”) algorithm) to generate a ML model that predicts whether a user is employed (i.e., employed correlates to an active status). In some embodiments, the ML model, for example, predicts whether a user will receive a paycheck by the next respective payday (e.g., as determined by the PD module). In some embodiments, the one or more decision engines (via the ML model for example) makes a prediction at the beginning of each pay cycle to predict paycheck availability at the end of the pay cycle. In some embodiments, the one or more decision engines performs an update to any prediction during a pay cycle based on a new evaluation in the middle of a pay cycle (e.g., update to an email, change in employment, etc.).

In some embodiments, the one or more decision engines applies one or more algorithms (e.g., an ML algorithm) to predict an employment status, where applying such an algorithm may be based on training data from historical records of users and other individuals (e.g., a cohort of individuals). In some embodiments, such training data includes labels for each set of respective data that corresponds to a user i) receiving a next paycheck (e.g., a next scheduled wages), or ii) not receiving a next paycheck (e.g., not receiving a next scheduled wages). In some embodiments, the set of respective data (both the training data, and corresponding data for the employee (referred to herein as “employment status data”)) includes one or more input parameters such as for example: past paycheck histories (such as missing records, paycheck sizes, arrival times, etc.), past user activities, which includes on the system (such as cashout/restore, login, CX contacts, etc.), past employment signal and earnings data, past bank transactions (such as spending behavior, competitor transactions, certain categories of trans. (loan, U-Haul, restaurant, etc.), etc.), and others.

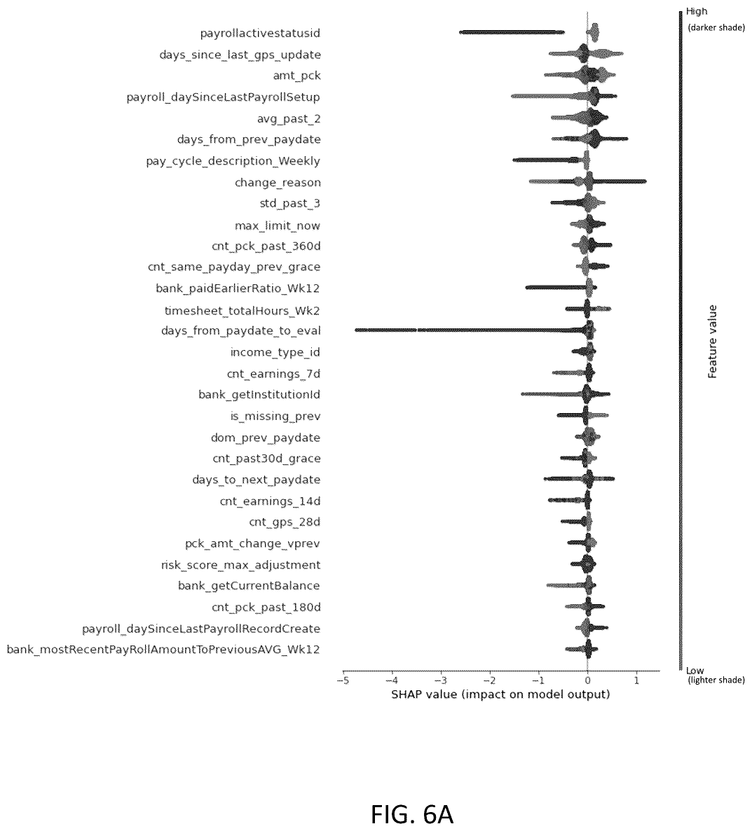

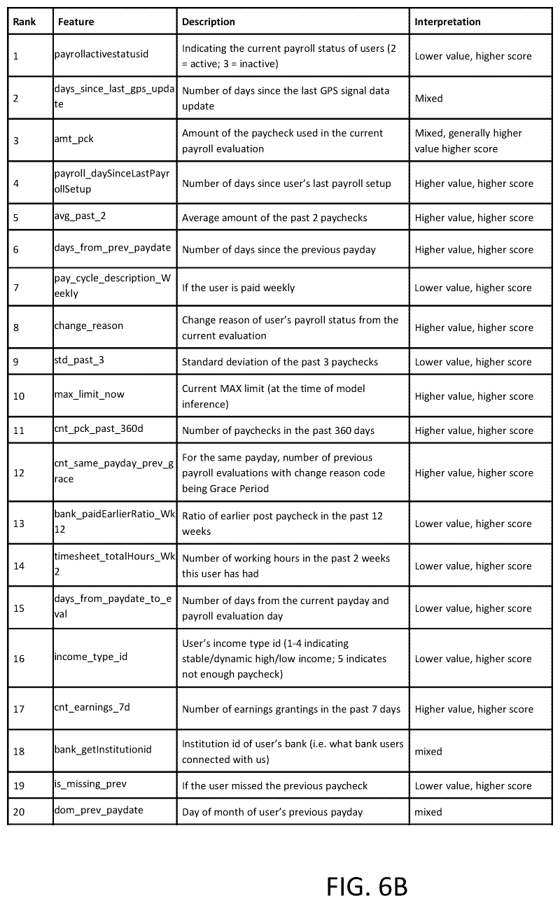

Accordingly, in some embodiments, the ML model, via the training model, includes one or more features associated with a given weight in an overall calculation for predicting whether a next paycheck will be received. In some embodiments, such weights are updated based on additional data being provided as part of the training model. FIG. 6A depicts exemplary features and a corresponding impact on the output for predicting a next paycheck, where the horizontal axis represents the impact on the output. FIG. 6B depicts a table of 20 exemplary features, and their corresponding impact based on a given value.

In some embodiments, using the ML model, the EG module, for each user, performs a periodic evaluation (or an evaluation for a new user), using the features corresponding to the user so as to predict a probability output on whether the user receives the next paycheck. In some embodiments, such periodic evaluation occurs daily, every 2, 3, 4, 5, or 6 days, weekly, bi-weekly, based on pay period, or any combination thereof.

In some embodiments, the system is configured to send an alert to the employee, a system administrator, or both, if it is predicted that the employee will not receive a next paycheck (e.g., next scheduled wages).

In some cases, the EG module confirms an active status (and/or “inactive status”) using one or more activity indicators, such as for example using a software application, for example Zoom or Microsoft Teams, determine whether the employee was listed as “available” during a given day. In some embodiments, the EG module is configured to determine how long such a signal was received from the employment computing device correlating to an active status (e.g., how long the employee had an “available” status, an “away” status, and/or an “offline” status). For example, in some cases, the EG module is configured to determine that a signal correlating to an active status was received for only 4 hours in a given day. Accordingly, in some cases, the EG module restricts the available earnings to 4 hours for that day. In some cases, the EG module sends an alert to the employee or other personnel to confirm whether the employee indeed only worked 4 hours.

In some embodiments, the EG module is configured to access the employee's account at a financial institution (as described herein), so as to determine whether a deposit related to the employee's wages (e.g., direct deposit, cash deposit, check deposit) was made according to the predictable pattern determined via the PD module. In some embodiments, where direct deposits and/or other deposits related to wages are configured to be deposited to the system, the EG module is configured to determine whether such deposit aligns with the predictable pattern determined via the PD module.

For example, in some embodiments, the EG module verifies whether the actual wages received for a given pay period (and after earnings was made available) was on time and/or within a tolerance of the predicted amount (e.g., wages received at an account in another financial institution). In some cases, if the wages were received within about 24 hours, 36 hours, 48 hours, or 72 hours of the predicted pay date (e.g., as determined by the PD module), the employee will remain in an active status (providing there are no other clearance issues). In some embodiments, if the amount of wages received was within 5%, 10%, or 25% of the predicted amount (e.g., as determined by the PD module), the employee will remain in an active status (providing no other clearance issues). In some embodiments, if the amount of wages received was within 5%, 10%, or 25% of the predicted amount (e.g., as determined by the PD module), the employee will remain in an active status (providing no other clearance issues). Accordingly, where wages are received and then used to pay back the advance wages (earnings) obtained by the employee, such earnings have been restored. For example, as described herein, a system account may be configured to disburse the earnings (e.g., advanced wages) to the employee. Upon receiving the scheduled wages (e.g., paycheck), which may be configured to be direct deposited into the same or a different system account or an employee account, the disbursed earnings may then be deposited into the system account (that disbursed the earnings) to restore the expenditures. In some embodiments, the system account may be specific to the employee. In some embodiments, the disbursed earnings may be funds that are already in the system account, or they may be funds located in another system account that provides disbursed earnings, and receives back the restored amount upon the employee receiving a pay check (e.g., scheduled wages).

In some cases, where the wages received is outside a tolerance for receipt date and/or amount, the EG module will restrict future earnings being made available, and/or provide an alert to the employee and/or other personnel to confirm the predicted pay amount and pay date. For example, in some cases, the employee may have switched employers, or took a leave of absence, or quit. In some embodiments, one or more occurrences of wages received being outside a tolerance in amount and/or date, and/or the employee not having an active status due to actual hours worked, may result in the employee being identified by the EG module with a risk for employment stability. In cases where insufficient wages are received (e.g., including no wages received) to pay back the advanced wages obtained by the employee, such earnings are associated with a restore failure designation (e.g., a restore fault). Accordingly, the EG module may restrict future earnings being available until the employee restores their stability, which may be for example, similar to the on-boarding process by the PD module, where multiple direct deposits (or other deposits relating to wages) may be required.

### Risk Module

In some embodiments, the Risk module 107 is configured to determine whether the employee is allowed to access the accumulated earnings during a given pay period. In some embodiments, the Risk module operates separately from the EG module. In some embodiments, the Risk module operates together with EG module to determine whether an employee is allowed to access earnings. In some embodiments, the EG module permits an employee to access their earnings based at least in part on information obtained via the Risk module.

In some embodiments, the Risk module is configured to determine a risk (e.g., risk level, risk score, etc.) associated with the employee, wherein the risk correlates at least in part as to whether the employee has and/or will earn wages so as to reconcile any earnings that were used (e.g., expenditures as described herein). For example, an employee determined with a high risk level may be attributed with a low likelihood of receiving wages as predicted (e.g., a next paycheck, next scheduled wages), while an employee with a low risk level may be attributed with a high likelihood of receiving wages as predicted. A high risk level may correlate with an inactive employment status, while a low risk level may correlate with an active employments status. In some embodiments, the risk (e.g., risk level, risk score, etc.) is determined based on or more risk factors. In some embodiments, the one or more risk factors comprise, financial institution (e.g., bank) transactions by the employee, email verification data, activity indicators (as described herein), location indicators (as described herein, e.g., when tracking location of the employee), other external data, or any combination thereof. For example, in some cases, the bank transactions relate to amount of wages actually deposited, frequency of wages deposited, amount of withdrawals, or any combination thereof. In some cases, a reduction in wages and/or one or more missed wages, as determined via deposits (e.g., direct deposits, cash deposits, check deposits, etc.), will be attributed with an increased risk (e.g., risk level, risk score, etc.). In some embodiments, a more frequent “inactive status”, for example as determined via email verification (as described herein), activity indicators, and/or location of employee, may result in an increased risk score. For example, in some cases, where the employee fails to verify email, has a decreased “available” status using activity indicators, and is detected (e.g., via a mobile device, an employee key card, etc.) to be outside an employment location for longer periods of time (or completely) will suggest the employee is not working according to a predetermined schedule, and thus access to the earnings may need to be restricted to avoid a risk of the employee using said earnings without having wages to reconcile with. In some embodiments, as described herein, one or more decision engines utilizes such risk factors for the employee stored as data on the system (e.g., risk factors data).

In some embodiments, the Risk module determines the risk (e.g., risk level, risk score, etc.) using one or more decision engines (as described herein). In some embodiments, the one or more decision engines applies one or more algorithms. In some cases, the Risk module uses a machine learning algorithm to better predict if an employee will not earn the predicted wages based on any combination of risk factors and other information relating to the employee. In some embodiments, the machine learning algorithm assigns weights for each risk factor data input, which is applied when determining an overall risk level. In some cases, the machine learning algorithm adjust risk scores based on historical data (e.g., trained data) for a given employee. For example, if in some cases the location indicators identify an employee outside of their employment location for a prolonged period, but the wages still arrive as predicted, the machine learning algorithm may not increase the risk score as significantly (or at all) if an employee is determined to be outside of their employment location for a prolonged period of time. In some case, the Risk module is configured to alert the employee regarding said detection of a risk factor, such that the employee can provide input as to any special considerations (e.g., occasional/routine site visits or other visits that is part of employment but outside of employment location).

In some embodiments, the Risk module is configured to communicate to the EG module the risk score, such that the EG module determines whether to restrict access to earnings.

### Routing Module

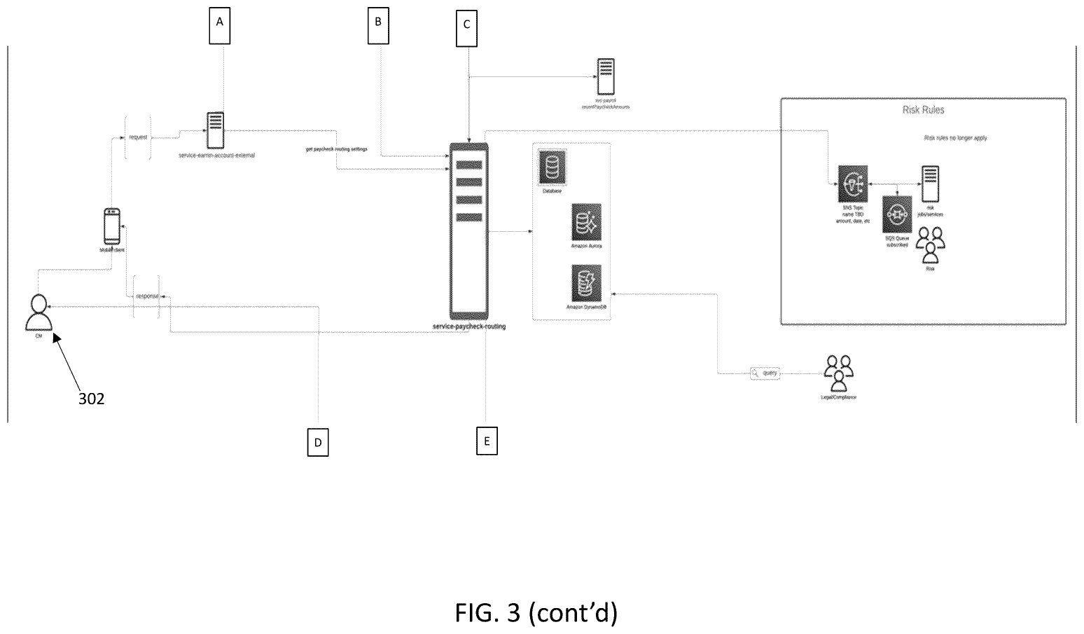

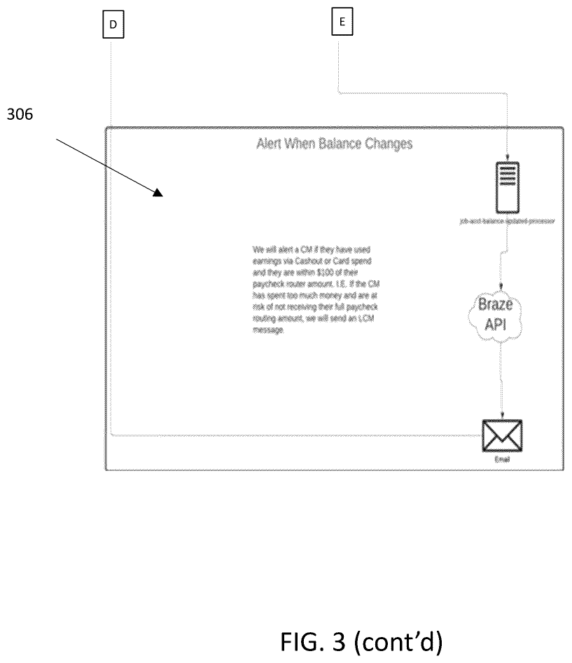

In some embodiments, the Routing module 108 is configured to automatically transfer a desired amount of wages received (e.g., paycheck) to another account (e.g., at a financial institution such as Bank of America, Chase, etc.). In some embodiments, such routing is based on the system (as described herein) receiving direct deposits, or other deposits of wages paid through employment. In some embodiments, the Routing module is configured to route a desired amount and/or proportion of the wages to another account, based on input provided by the employee (e.g., via an interface of the system, such as the Earnings tool). For example, in some embodiments, the Routing module is configured to interface with a payroll system so as to distribute the scheduled wages (e.g. wages earned and paid on the paydate of a pay cycle, as described herein) according to one or more predetermined criteria, which may include the desired amount. In some embodiments, the Routing module is configured to act as a payroll system so as to distribute the scheduled wages (e.g. wages earned and paid on the paydate of a pay cycle, as described herein) according to one or more predetermined criteria, which may include the desired amount. In some embodiments, the desired amount can be any amount (e.g., $0, $100, $300, $500, a custom amount, etc.). In some embodiments, the Routing module limits the desired amount to the amount of the wages received (for a given pay period). FIG. 2 provides an exemplary depiction of a display in communication with the Routing module, configured receive input relating to an amount of wages to be routed to another account. FIG. 3 provides an exemplary flow chart of the Routing module operation.

In some embodiments, the user (e.g., employee) is allowed to update the amount to be routed as many times as they like. As depicted in FIG. 3, in some embodiments, when setting an amount to be routed (see 304 in FIG. 3), the Routing module may limit and/or send an alert if said desired amount to be routed may exceed an amount available (e.g., based on expected wages received, expenditures, accessed earnings (e.g., advanced wages), etc). In some cases, the employee (e.g., 302 in FIG. 3) is configured to force a desired amount to be routed to be set despite receiving an alert by the Routing module.

In some embodiments, the AE module is configured to limit available earnings (in a given pay period) accessible to the employee based on the difference between the amount of wages received and the desired amount to be transferred.

In some embodiments, the amount of available earnings is not limited, but instead, the actual amount of wages routed is reduced if the sum of the desired amount (to be routed) and the expenditures is greater than the amount of wages. For example, if the wages received is $1,000, and the desired amount to be transferred is $1,000, wherein if the expenditures is $300, then the actual amount routed is reduced to $700 (i.e., a partial transfer). See Example 1 herein.

In some embodiments, the Routing module is configured to provide an alert if a desired routing amount is impacted due to expenditures made (e.g., if the amount of wages will be less than a threshold amount after expenditures is deducted, and/or if the desired routing amount is greater than what's left of the wages)—see for example 306 in FIG. 3. As described herein, in some embodiments, the expenditures correspond to payments made, transfer of earnings to another account or individual, and/or withdrawal of earnings. Accordingly, the expenditures may refer to the earnings accessed by the employee ahead of receiving the wages during the pay period.

In some embodiments, as described herein, the Routing module is configured to interface with and/or operate as a payroll system for an employer, wherein the Routing module is configured to distribute the scheduled wages on the paydate according to one or more predetermined criteria, which may include the desired amount as specified by the employee (and as described herein). In some embodiments, the Routing module is configured to receive the scheduled wages (e.g., via an account associated with and/or in communication with the system), and distribute according to the one or more predetermined criteria, as described herein. In some embodiments, the Routing module distributes the scheduled wages regardless of any expenditures made by the employee.

In some embodiments, the desired amount corresponds to one or more amounts of funds to be transferred to two or more different accounts. For example, in some embodiments, in addition to or alternative to routing a desired amount of funds to a banking account (e.g., personal banking account), the Routing module is configured to distribute funds for a credit card payment, or other type of billing embodiments.

In some embodiments, the Routing module is configured to distribute the scheduled wages, including distributions of a desired amount to one or more accounts, according to a desired timing, and thus distribution of the scheduled wages may not all occur on the pay date of said scheduled wages. For example, in some embodiments, the Routing module is configured to distribute funds for a credit card payment and/or other type of billing according to a certain date. In some embodiments, said desired amount of funds is held in an account associated with and/or in communication with the system (as described herein), and wherein the Routing module transfers to a respective account a desired amount according to a schedule. Accordingly, in some embodiments, the Routing module is configured to enable the scheduled wages to be distributed at different time intervals. In some embodiments, as described herein, such transfer of a desired amount is subject to any expenditures made by the employee.

In some embodiments, the one or more predetermined criteria comprises paying back any ependitures of the available earnings, reserving funds against any additional balances associated with the system (e.g., an Earning Card, as described herein), routing one or more desired amounts to one or more accounts, or any combination thereof.

In some embodiments, upon receiving the wages for a given pay period, the Routing module is configured to, in this order (see also 308 in FIG. 3), 1) reconcile (e.g., pay back) expenditures of the available earnings (e.g., restore), 2) reserve funds against any additional card balance associated with the system, such that said funds cannot be used by the employee, 3) route the desired amount or a reduced desired amount to another account, wherein such routing may be according to a desired schedule, and 4) place any remaining amount to an account associated with system (e.g., “cash” in FIG. 1B). In some embodiments, said account refers to a secured account (which may be associated with the Earning card), as described in U.S. Provisional application 63/421,519, which is incorporated herein in its entirety. In some embodiments, routing the desired amount (indicated as third in the order of which the Routing module reconciles received wages) can occur at different time intervals if amounts are being transferred to one or more accounts (as described herein). In some cases, where 1) and 2) exhaust all the wages amount, there will be no amount available for transferring any amount to any other account.

In some embodiments, for uses utilizing the Earning card, the Routing module incorporates an effective pay period max for calculating a maximum amount that may be withdrawn. In some embodiments, the Earning card usage and/or an amount of funds available to be transferred to another account (as described herein) is limited to allow a certain amount or percentage of a paycheck to be withdrawn or used. For example, in some embodiments, the maximum amount of funds and/or earnings that can be accessed via the Earlings card is $500, $1000, $1500, or more. In some embodiments, the maximum proportion of a paycheck amount that can be accessed via the Earnings Card is about 70%, 75%, 80%, or 90% (e.g., up to 80%) of the total paycheck amount. Accordingly, in some embodiments, the Routing module is configured to determine an effective pay period max (for determining how much can be accessed via the EarnIn Card) based on a minimum of i) the upper limit that can be accessed and/or used by the Earnings Card, ii) the maximum proportion of a paycheck that can be accessed and/or used via the Earnings Card, and iii) the paycheck less any expenditures (e.g., cashout, accessed earnings (accessed unpaid wages)). Example 2 herein provides different examples of this effective pay period max.

III. Computer Implementation

The system and methods described herein, including the system for determining available earnings for an employee, including verification of employment status, are, in some embodiments, performed on one or more computers.

For example, the building and deployment of any system described herein can be implemented in hardware or software, or a combination of both. In one embodiment, a machine-readable storage medium is provided, the medium comprising a data storage material encoded with machine readable data which, when using a machine programmed with instructions for using said data, is capable of executing any one of the methods described herein and/or displaying any of the datasets or results (e.g., available earnings, employment status, employment stability) described herein. Some embodiments can be implemented in computer programs executing on programmable computers, comprising a processor and a data storage system (including volatile and non-volatile memory and/or storage elements), and optionally including a graphics adapter, a pointing device, a network adapter, at least one input device, and/or at least one output device. A display may be coupled to the graphics adapter. Program code is applied to input data to perform the functions described above and generate output information. The output information is applied to one or more output devices, in known fashion. The computer can be, for example, a personal computer, microcomputer, or workstation of conventional design.

Each program can be implemented in a high-level procedural or object-oriented programming language to communicate with a computer system. However, the programs can be implemented in assembly or machine language, if desired. In any case, the language can be a compiled or interpreted language. Each such computer program is preferably stored on a storage media or device (e.g., ROM or magnetic diskette) readable by a general or special purpose programmable computer, for configuring and operating the computer when the storage media or device is read by the computer to perform the procedures described herein. The system can also be considered to be implemented as a computer-readable storage medium, configured with a computer program, where the storage medium so configured causes a computer to operate in a specific and predefined manner to perform the functions described herein.

The signature patterns and databases thereof can be provided in a variety of media to facilitate their use. “Media” refers to a manufacture that contains the signature pattern information of an embodiment. The databases of some embodiments can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art can readily appreciate how any of the presently known computer readable mediums can be used to create a manufacture comprising a recording of the present database information. “Recorded” refers to a process for storing information on computer readable medium, using any such methods as known in the art. Any convenient data storage structure can be chosen, based on the means used to access the stored information. A variety of data processor programs and formats can be used for storage, e.g., word processing text file, database format, etc.

In some embodiments, the systems and methods described herein, including the systems and methods for determining available earnings and employment status, are performed on one or more computers in a distributed computing system environment (e.g., in a cloud computing environment). In this description, “cloud computing” is defined as a model for enabling on-demand network access to a shared set of configurable computing resources. Cloud computing can be employed to offer on-demand access to the shared set of configurable computing resources. The shared set of configurable computing resources can be rapidly provisioned via virtualization and released with low management effort or service provider interaction, and then scaled accordingly. A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 4 illustrates an example computer for implementing the entities shown in FIGS. 1-3. The computer 400 includes at least one processor 402 coupled to a chipset 404. The chipset 404 includes a memory controller hub 420 and an input/output (I/O) controller hub 422. A memory 406 and a graphics adapter 412 are coupled to the memory controller hub 420, and a display 418 is coupled to the graphics adapter 412. A storage device 408, an input device 414, and network adapter 416 are coupled to the I/O controller hub 422. Other embodiments of the computer 400 have different architectures.

The storage device 408 is a non-transitory computer-readable storage medium such as a hard drive, compact disk read-only memory (CD-ROM), DVD, or a solid-state memory device. The memory 406 holds instructions and data used by the processor 402. The input interface 414 is a touch-screen interface, a mouse, track ball, or other type of pointing device, a keyboard, or some combination thereof, and is used to input data into the computer 400. In some embodiments, the computer 400 may be configured to receive input (e.g., commands) from the input interface 414 via gestures from the user. The network adapter 416 couples the computer 400 to one or more computer networks.

The graphics adapter 412 displays images and other information on the display 418. In various embodiments, the display 418 is configured such that the user may (e.g., employee, personnel associated with system) may input user selections on the display 418 to, for example, initiate the system for determining available earnings and/or employment status. In one embodiment, the display 418 may include a touch interface. In various embodiments, the display 418 can show available earnings and funds associated with a profile of the employee.

The computer 400 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 408, loaded into the memory 406, and executed by the processor 402.

The types of computers 400 used by the entities of FIGS. 1 and 2 can vary depending upon the embodiment and the processing power required by the entity. For example, the earnings tool 100 can run in a single computer 400 or multiple computers 400 communicating with each other through a network such as in a server farm. The computers 400 can lack some of the components described above, such as graphics adapters 412, and displays 418.

### Machine Learning Algorithm

In some embodiments, the processor applies one or more algorithms to predict an employment status of a user, and whether they will receive a next paycheck (as described herein). In some embodiments, each algorithm may correspond to determining whether a next paycheck will be received for a given number of parameters associated with the user (as described herein). In some embodiments, the one or more processors apply algorithms (e.g., algorithms embodied in trained models) to correlate the various combinations of parameters associated with the user and/or employment (as described herein). In some embodiments, at least one of the one or more algorithms may comprise a machine learning algorithm incorporating artificial intelligence (AI) to help determine whether a next paycheck will be received, as described herein. For example, in some embodiments, said artificial intelligence is applied to trained model data (which may be included in the decision engine data) and optionally existing user data (such as historical data correlating parameters, such as those exemplified in FIGS. 6A-6B), thereby training the model. In some embodiments, data obtained from such past users can be integrated for improved decision making, improved quality and productivity and efficiency in the predicting an employment status of a user.

In some embodiments, any one of the decision engine(s) described herein is any one of a regression model (e.g., linear regression, logistic regression, or polynomial regression), decision tree, random forest, gradient boosted machine learning model, support vector machine, Naïve Bayes model, k-means cluster, or neural network (e.g., feed-forward networks, convolutional neural networks (CNN), deep neural networks (DNN), autoencoder neural networks, generative adversarial networks, or recurrent networks (e.g., long short-term memory networks (LSTM), bi-directional recurrent networks, deep bi-directional recurrent networks), or any combination thereof. In particular embodiments, any one of the decision engine(s) described herein is a logistic regression model. In particular embodiments, any one of the decision engine(s) described herein is a random forest classifier. In particular embodiments, any one of the decision engine(s) described herein is a gradient boosting model.

In some embodiments, any one of the decision engine(s) described herein (e.g., a trained model) can be trained using a machine learning implemented method, such as any one of a linear regression algorithm, logistic regression algorithm, decision tree algorithm, support vector machine classification, Naïve Bayes classification, K-Nearest Neighbor classification, random forest algorithm, deep learning algorithm, gradient boosting algorithm, and dimensionality reduction techniques such as manifold learning, principal component analysis, factor analysis, autoencoder regularization, and independent component analysis, or combinations thereof. In particular embodiments, the machine learning implemented method is a logistic regression algorithm. In particular embodiments, the machine learning implemented method is a random forest algorithm. In particular embodiments, the machine learning implemented method is a gradient boosting algorithm, such as Xgboost. In some embodiments, any one of the trained model(s) described herein is trained using supervised learning algorithms, unsupervised learning algorithms, semi-supervised learning algorithms (e.g., partial supervision), weak supervision, transfer, multi-task learning, or any combination thereof.

In some embodiments, any one of the trained model(s) described herein has one or more parameters, such as hyperparameters or model parameters. Hyperparameters are generally established prior to training. Examples of hyperparameters include the learning rate, depth or leaves of a decision tree, number of hidden layers in a deep neural network, number of clusters in a k-means cluster, penalty in a regression model, and a regularization parameter associated with a cost function. Model parameters are generally adjusted during training. Examples of model parameters include weights associated with nodes in layers of neural network, support vectors in a support vector machine, node values in a decision tree, and coefficients in a regression model.

In some embodiments, any one of the trained model(s) described herein are trained via training data located in the trained model data (which may be in communication with the processor 108).

In various embodiments, the training data used for training any one of the trained model(s) described herein includes reference ground truths that indicate one or more press conditions associated with a desired press cut(s) (hereafter also referred to as “positive” or “+”) or whether one or more press conditions were not associated with a desired press cut(s) (hereafter also referred to as “negative” or “−”). In various embodiments, the reference ground truths in the training data are binary values, such as “1” or “0.” For example, one or more parameters associated with a next paycheck received status can be identified in the training data with a value of “1” whereas one or more parameters not associated with a next paycheck received status can be identified in the training data with a value of “0.” In various embodiments, any one of the trained model(s) described herein are trained using the training data to minimize a loss function such that any one of the trained model(s) described herein can better predict the outcome (e.g., quality of press cuts) based on the input (e.g., one or more press conditions, characteristics of a juice, etc.). In some embodiments, the loss function is constructed for any of a least absolute shrinkage and selection operator (LASSO) regression, Ridge regression, or ElasticNet regression. In some embodiments, any one of the trained model(s) described herein is a random forest model, and is trained to minimize one of Gini impurity or Entropy metrics for feature splitting, thereby enabling any one of the trained model(s) described herein to better predict whether a user will receive a next paycheck.

In some embodiments, historical data relating to users, parameters and whether a next paycheck was received, as obtained via the system 100 is stored in the computing system (e.g., see FIG. 4) and in communication (and accessible) with the processor. In some embodiments, the historical data is updated via communication with an external database (including other internet sources), and/or is updated based on parameters and/or conditions inputted by the operator.

### EXAMPLES

### Example 1—Partial Amount Routing

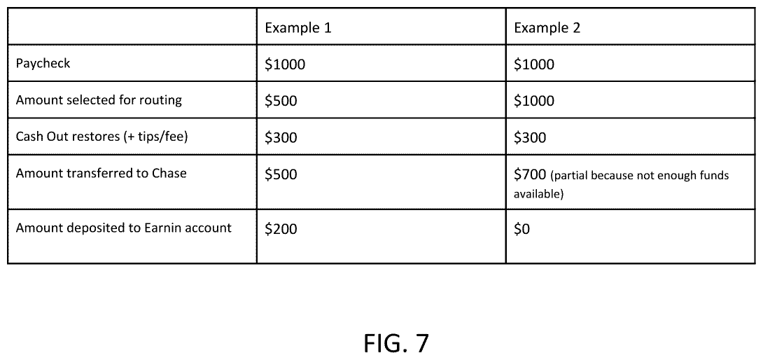

FIG. 7 depicts an example of two cases for routing an amount of a paycheck to an external account (e.g., a Chase bank account). In the first exemplary case, the paycheck is $1000, and the desired amount to be routed is $500. Given that the expenditures (including cash outs) were only $300, this left $700 of the amount of wages to be routed, thereby allowing the full $500 to be transferred (the balance could be deposited into the system account, see FIG. 2 for example). By contrast, in the second exemplary case, where the paycheck is again $1000, the desired amount to be routed was the full paycheck amount ($1000), and thus with $300 in expenditures that needed to be paid pack, only $700 was available to be routed (i.e., a partial routing). Thus, no money was available to be deposited into the system account.

### Exemplary Embodiments

Disclosed herein, in some aspects, is a system for automatically partitioning and transferring scheduled wages based on advanced wages disbursed for a pay period prior to receiving the scheduled wages, the system comprising one or more processors; and one or more memories storing instructions that, when executed by the one or more processors, cause the system to perform operations including: identifying a predictable pattern for i) the amount of scheduled wages received by the employee, ii) the frequency of the scheduled wages received, iii) a rate at which the scheduled wages are accrued during the pay period (“pay rate”), or iv) a combination thereof; receiving, from the employee, input relating to a desired amount of advanced wages to be transferred to a financial account associated with the employee (“employee account”); calculating a distribution of the scheduled wages based on i) the predictable pattern amount of scheduled wages, ii) the advanced wages disbursed to the employee during the pay period, iii) outstanding advanced wages from a previous pay period, iv) the desired amount of advanced wages to be transferred, or v) a combination thereof, wherein the one or more processors is configured to determine an available transfer amount that is less than or equal to the desired amount; and automatically transferring the available transfer amount to the employee account from a financial account associated with the system (“system account”), wherein the system account is configured to receive the scheduled wages; wherein any one of the one or more processors is configured to be in communication with the employee account, the system account, or both, so as to perform operations from one or more of (a)-(d).

In some embodiments, the available transfer amount is based on a difference between an amount of scheduled wages received and the advanced wages disbursed to the employee during the i) pay period and/or ii) one or more previous pay periods, such that i) if the difference is greater than the desired amount, the available transfer amount equals the desired amount, and ii) if the difference is less than the desired amount, the available transfer amount equals at most the difference. In some embodiments, the operations further include sending an alert to the employee, a system administrator, or both, when the determined available transfer amount is less than the desired amount. In some embodiments, the operations further include limiting the available transfer amount to a maximum threshold amount and/or a maximum percentage of the predicted pattern amount of the scheduled wages. In some embodiments, the maximum threshold amount is about $250, $500, $1000, $2000, or $5000. In some embodiments, the maximum percentage is at most 50%, 60%, 75%, or 90% of the predicted pattern amount of the scheduled wages.

In some embodiments, the operations further include verifying an employment status of the employee during the pay period, the employment status corresponding to an active status or an inactive status, wherein an active status corresponds a prediction of the employee receiving the next scheduled wages, and an inactive status corresponds to a prediction of the employee not receiving the next scheduled wages.

In some embodiments, verifying the employment status comprises predicting whether the employee will receive a next scheduled wages using a first decision engine by the one or more processors, wherein an active status corresponds to an employee receiving the next scheduled wages. In some embodiments, the first decision engine comprises a trained model, a decision tree, an analytical expression, or a combination thereof. In some embodiments, the first decision engine applies one or more employment status data for the employee, the employment status data comprising past scheduled wages data, past employee financial activities data, past disbursed advanced wages data, past restore faults data, or a combination thereof, to predict whether the employee will receive the next scheduled wages. In some embodiments, the first decision engine applies the one or more employments status data using a machine learning model. In some embodiments, the machine learning model incorporates a respective weight for each type of employment status data, wherein each respective weight is determined using trained data of historical employment status data relating to the employee, from a cohort of individuals, or both, wherein each data input is correlated with whether i) the respective individual of the cohort of individuals, or ii) employee, received scheduled wages for a given pay period. In some embodiments, past scheduled wages data comprises receipt of on-time scheduled wages, missing scheduled wages, the amount of scheduled wages with respect to the predicted pattern amount, or any combination thereof.

In some embodiments, past employee financial activities comprises transactions at a financial account associated with the employee, spending by the employee, or both. In some embodiments, the operations further include performing an employment status prediction at the beginning of each pay period. In some embodiments, the one or more processors is further configured to send an alert to the employee, a system administrator, or both, if the employee is predicted not to received the next scheduled wages.

In some embodiments, verifying the employment status comprises determining an employee risk level using a second decision engine by the one or more processors. In some embodiments, a high risk level correlates with a low likelihood of the employee receiving the scheduled wages and an inactive status, and a low risk level correlates with a high likelihood of the employee receiving the scheduled wages and an active status. In some embodiments, the second decision engine applies one or more risk factors data comprising transactions at the employee account data, past verifications of the employee email account data, past verifications of the location of the employee data, past restore faults data, income stability data, past employment inactive status data, or a combination thereof, to determine an employee risk level. In some embodiments, the second decision engine applies the one or more risk factors data using a machine learning model. In some embodiments, the machine learning model incorporates a respective weight for each type of risk factor data, wherein each respective weight is determined using trained data of historical risk factor data relating to the employee, wherein each data input is correlated with whether the employee received the scheduled wages for a given pay period.

Disclosed herein, in other aspects, is a non-transitory computer readable medium for disbursing advanced wages to an employee prior to a payment date of scheduled wages for a pay period, the non-transitory computer readable medium comprising instructions that, when executed by a processor, cause the processor to perform operations including: identifying a predictable pattern for i) the amount of scheduled wages received by the employee, ii) the frequency of the scheduled wages received, iii) a rate at which the scheduled wages are accrued during the pay period (“pay rate”), or iv) a combination thereof; receiving, from the employee, input relating to a desired amount of advanced wages to be transferred to a financial account associated with the employee (“employee account”); calculating a distribution of the scheduled wages based on i) the predictable pattern amount of scheduled wages, ii) the advanced wages disbursed to the employee during the pay period, iii) outstanding advanced wages from a previous pay period, iv) the desired amount of advanced wages to be transferred, or v) a combination thereof, wherein the processor is configured to determine an available transfer amount that is less than or equal to the desired amount; and automatically transferring the available transfer amount to the employee account from a financial account associated with a system (“system account”), wherein the system account is configured to receive the scheduled wages; wherein any one of the processor is configured to be in communication with the employee account, the system account, or both, so as to perform operations from one or more of (a)-(d).

In some embodiments, the available transfer amount is based on a difference between an amount of scheduled wages received and the advanced wages disbursed to the employee during the i) pay period and/or ii) one or more previous pay periods, such that i) if the difference is greater than the desired amount, the available transfer amount equals the desired amount, and ii) if the difference is less than the desired amount, the available transfer amount equals at most the difference.

In some embodiments, the operations further include sending an alert to the employee, a system administrator, or both, when the determined available transfer amount is less than the desired amount. In some embodiments, the operations further include limiting the available transfer amount to a maximum threshold amount and/or a maximum percentage of the predicted pattern amount of the scheduled wages. In some embodiments, the maximum threshold amount is about $250, $500, $1000, $2000, or $5000. In some embodiments, the maximum percentage is at most 50%, 60%, 75%, or 90% of the predicted pattern amount of the scheduled wages.

In some embodiments, the operations further include verifying an employment status of the employee during the pay period, the employment status corresponding to an active status or an inactive status, wherein an active status corresponds a prediction of the employee receiving the next scheduled wages, and an inactive status corresponds to a prediction of the employee not receiving the next scheduled wages.

In some embodiments, verifying the employment status comprises predicting whether the employee will receive a next scheduled wages using a first decision engine by the processor, wherein an active status corresponds to an employee receiving the next scheduled wages. In some embodiments, the first decision engine comprises a trained model, a decision tree, an analytical expression, or a combination thereof. In some embodiments, the first decision engine applies one or more employment status data for the employee, the employment status data comprising past scheduled wages data, past employee financial activities data, past disbursed advanced wages data, past restore faults data, or a combination thereof, to predict whether the employee will receive the next scheduled wages. In some embodiments, the first decision engine applies the one or more employments status data using a machine learning model. In some embodiments, the machine learning model incorporates a respective weight for each type of employment status data, wherein each respective weight is determined using trained data of historical employment status data relating to the employee, from a cohort of individuals, or both, wherein each data input is correlated with whether i) the respective individual of the cohort of individuals, or ii) employee, received scheduled wages for a given pay period.

In some embodiments, past scheduled wages data comprises receipt of on-time scheduled wages, missing scheduled wages, the amount of scheduled wages with respect to the predicted pattern amount, or any combination thereof. In some embodiments, past employee financial activities comprises transactions at a financial account associated with the employee, spending by the employee, or both. In some embodiments, the operations further include performing an employment status prediction at the beginning of each pay period. In some embodiments, the processor is further configured to send an alert to the employee, a system administrator, or both, if the employee is predicted not to received the next scheduled wages.

In some embodiments, verifying the employment status comprises determining an employee risk level using a second decision engine by the processor. In some embodiments, a high risk level correlates with a low likelihood of the employee receiving the scheduled wages and an inactive status, and a low risk level correlates with a high likelihood of the employee receiving the scheduled wages and an active status. In some embodiments, the second decision engine applies one or more risk factors data comprising transactions at the employee account data, past verifications of the employee email account data, past verifications of the location of the employee data, past restore faults data, income stability data, past employment inactive status data, or a combination thereof, to determine an employee risk level. In some embodiments, the second decision engine applies the one or more risk factors data using a machine learning model. In some embodiments, the machine learning model incorporates a respective weight for each type of risk factor data, wherein each respective weight is determined using trained data of historical risk factor data relating to the employee, wherein each data input is correlated with whether the employee received the scheduled wages for a given pay period.

Disclosed here, in other aspects, is a method for disbursing advanced wages to an employee prior to a payment date of scheduled wages for a pay period, the method comprising: identifying a predictable pattern for i) the amount of scheduled wages received by the employee, ii) the frequency of the scheduled wages received, iii) a rate at which the scheduled wages are accrued during the pay period (“pay rate”), or iv) a combination thereof; receiving, from the employee, input relating to a desired amount of advanced wages to be transferred to a financial account associated with the employee (“employee account”); calculating a distribution of the scheduled wages based on i) the predictable pattern amount of scheduled wages, ii) the advanced wages disbursed to the employee during the pay period, iii) outstanding advanced wages from a previous pay period, iv) the desired amount of advanced wages to be transferred, or v) a combination thereof, wherein an available transfer amount that is less than or equal to the desired amount is determined; and automatically transferring the available transfer amount to the employee account from a financial account associated with a system (“system account”), wherein the system account is configured to receive the scheduled wages.

In some embodiments, the available transfer amount is based on a difference between an amount of scheduled wages received and the advanced wages disbursed to the employee during the i) pay period and/or ii) one or more previous pay periods, such that i) if the difference is greater than the desired amount, the available transfer amount equals the desired amount, and ii) if the difference is less than the desired amount, the available transfer amount equals at most the difference.

In some embodiments, the method further comprises sending an alert to the employee, a system administrator, or both, when the determined available transfer amount is less than the desired amount. In some embodiments, the method further comprises limiting the available transfer amount to a maximum threshold amount and/or a maximum percentage of the predicted pattern amount of the scheduled wages. In some embodiments, the maximum threshold amount is about $250, $500, $1000, $2000, or $5000. In some embodiments, the maximum percentage is at most 50%, 60%, 75%, or 90% of the predicted pattern amount of the scheduled wages.

In some embodiments, the method further comprises an employment status of the employee during the pay period, the employment status corresponding to an active status or an inactive status, wherein an active status corresponds a prediction of the employee receiving the next scheduled wages, and an inactive status corresponds to a prediction of the employee not receiving the next scheduled wages.

In some embodiments, verifying the employment status comprises predicting whether the employee will receive a next scheduled wages using a first decision engine, wherein an active status corresponds to an employee receiving the next scheduled wages. In some embodiments, the first decision engine comprises a trained model, a decision tree, an analytical expression, or a combination thereof. In some embodiments, the first decision engine applies one or more employment status data for the employee, the employment status data comprising past scheduled wages data, past employee financial activities data, past disbursed advanced wages data, past restore faults data, or a combination thereof, to predict whether the employee will receive the next scheduled wages. In some embodiments, the first decision engine applies the one or more employments status data using a machine learning model. In some embodiments, the machine learning model incorporates a respective weight for each type of employment status data, wherein each respective weight is determined using trained data of historical employment status data relating to the employee, from a cohort of individuals, or both, wherein each data input is correlated with whether i) the respective individual of the cohort of individuals, or ii) employee, received scheduled wages for a given pay period.

In some embodiments, past scheduled wages data comprises receipt of on-time scheduled wages, missing scheduled wages, the amount of scheduled wages with respect to the predicted pattern amount, or any combination thereof. In some embodiments, past employee financial activities comprises transactions at a financial account associated with the employee, spending by the employee, or both. In some embodiments, the method further comprises performing an employment status prediction at the beginning of each pay period. In some embodiments, the method further comprises sending an alert to the employee, a system administrator, or both, if the employee is predicted not to received the next scheduled wages. In some embodiments, verifying the employment status comprises determining an employee risk level using a second decision engine. In some embodiments, a high risk level correlates with a low likelihood of the employee receiving the scheduled wages and an inactive status, and a low risk level correlates with a high likelihood of the employee receiving the scheduled wages and an active status. In some embodiments, the second decision engine applies one or more risk factors data comprising transactions at the employee account data, past verifications of the employee email account data, past verifications of the location of the employee data, past restore faults data, income stability data, past employment inactive status data, or a combination thereof, to determine an employee risk level. In some embodiments, the second decision engine applies the one or more risk factors data using a machine learning model. In some embodiments, the machine learning model incorporates a respective weight for each type of risk factor data, wherein each respective weight is determined using trained data of historical risk factor data relating to the employee, wherein each data input is correlated with whether the employee received the scheduled wages for a given pay period.

All publications, patents, patent applications and other documents cited in this application are hereby incorporated by reference herein in their entireties for all purposes to the same extent as if each individual publication, patent, patent application or other document were individually indicated to be incorporated by reference for all purposes.

While various specific embodiments have been illustrated and described, the above specification is not restrictive. It will be appreciated that various changes can be made without departing from the spirit and scope of the present disclosure(s). Many variations will become apparent to those skilled in the art upon review of this specification.

1. A system for automatically partitioning and transferring scheduled wages based on advanced wages disbursed for a pay period prior to receiving the scheduled wages, the system comprising one or more processors; and one or more memories storing instructions that, when executed by the one or more processors, cause the system to perform operations including:
(a) identifying a predictable pattern for i) the amount of scheduled wages received by the employee, ii) the frequency of the scheduled wages received, iii) a rate at which the scheduled wages are accrued during the pay period (“pay rate”), or iv) a combination thereof;
(b) receiving, from the employee, input relating to a desired amount of advanced wages to be transferred to a financial account associated with the employee (“employee account”);
(c) calculating a distribution of the scheduled wages based on i) the predictable pattern amount of scheduled wages, ii) the advanced wages disbursed to the employee during the pay period, iii) outstanding advanced wages from a previous pay period, iv) the desired amount of advanced wages to be transferred, or v) a combination thereof, wherein the one or more processors is configured to determine an available transfer amount that is less than or equal to the desired amount; and
(d) automatically transferring the available transfer amount to the employee account from a financial account associated with the system (“system account”), wherein the system account is configured to receive the scheduled wages;
wherein any one of the one or more processors is configured to be in communication with the employee account, the system account, or both, so as to perform operations from one or more of (a)-(d).

2. The system of claim 1, wherein the available transfer amount is based on a difference between an amount of scheduled wages received and the advanced wages disbursed to the employee during the i) pay period and/or ii) one or more previous pay periods, such that i) if the difference is greater than the desired amount, the available transfer amount equals the desired amount, and ii) if the difference is less than the desired amount, the available transfer amount equals at most the difference.

3. The system of claim 1, wherein the operations further include sending an alert to the employee, a system administrator, or both, when the determined available transfer amount is less than the desired amount.

4. The system of claim 1, wherein the operations further include limiting the available transfer amount to a maximum threshold amount and/or a maximum percentage of the predicted pattern amount of the scheduled wages.

5. (canceled)

6. (canceled)

7. The system of claim 1, wherein the operations further include verifying an employment status of the employee during the pay period, the employment status corresponding to an active status or an inactive status, wherein an active status corresponds a prediction of the employee receiving the next scheduled wages, and an inactive status corresponds to a prediction of the employee not receiving the next scheduled wages.

8. The system of claim 7, wherein verifying the employment status comprises predicting whether the employee will receive a next scheduled wages using a first decision engine by the one or more processors, wherein an active status corresponds to an employee receiving the next scheduled wages.

9. (canceled)

10. The system of claim 8, wherein the first decision engine applies one or more employment status data for the employee, the employment status data comprising past scheduled wages data, past employee financial activities data, past disbursed advanced wages data, past restore faults data, or a combination thereof, to predict whether the employee will receive the next scheduled wages.

11. (canceled)

12. The system of claim 10, wherein the first decision engine applies the one or more employments status data using a machine learning model, wherein the machine learning model incorporates a respective weight for each type of employment status data, wherein each respective weight is determined using trained data of historical employment status data relating to the employee, from a cohort of individuals, or both, wherein each data input is correlated with whether i) the respective individual of the cohort of individuals, or ii) employee, received scheduled wages for a given pay period.

13. The system of claim 10, wherein past scheduled wages data comprises receipt of on-time scheduled wages, missing scheduled wages, the amount of scheduled wages with respect to the predicted pattern amount, or any combination thereof.

14. The system of claim 10, wherein past employee financial activities comprises transactions at a financial account associated with the employee, spending by the employee, or both.

15. (canceled)

16. The system of claim 10, wherein the one or more processors is further configured to send an alert to the employee, a system administrator, or both, if the employee is predicted not to received the next scheduled wages.

17. The system of claim 7, wherein verifying the employment status comprises determining an employee risk level using a second decision engine by the one or more processors.

18. (canceled)

19. The system of claim 17, wherein the second decision engine applies one or more risk factors data comprising transactions at the employee account data, past verifications of the employee email account data, past verifications of the location of the employee data, past restore faults data, income stability data, past employment inactive status data, or a combination thereof, to determine an employee risk level.

20. (canceled)

21. The system of claim 19, wherein the second decision engine applies the one or more risk factors data using a machine learning model, wherein the machine learning model incorporates a respective weight for each type of risk factor data, wherein each respective weight is determined using trained data of historical risk factor data relating to the employee, wherein each data input is correlated with whether the employee received the scheduled wages for a given pay period.

22.-42. (canceled)

43. A method for disbursing advanced wages to an employee prior to a payment date of scheduled wages for a pay period, the method comprising:
a. identifying a predictable pattern for i) the amount of scheduled wages received by the employee, ii) the frequency of the scheduled wages received, iii) a rate at which the scheduled wages are accrued during the pay period (“pay rate”), or iv) a combination thereof;
b. receiving, from the employee, input relating to a desired amount of advanced wages to be transferred to a financial account associated with the employee (“employee account”);
c. calculating a distribution of the scheduled wages based on i) the predictable pattern amount of scheduled wages, ii) the advanced wages disbursed to the employee during the pay period, iii) outstanding advanced wages from a previous pay period, iv) the desired amount of advanced wages to be transferred, or v) a combination thereof, wherein an available transfer amount that is less than or equal to the desired amount is determined; and
d. automatically transferring the available transfer amount to the employee account from a financial account associated with a system (“system account”), wherein the system account is configured to receive the scheduled wages.

44. The method of claim 43, wherein the available transfer amount is based on a difference between an amount of scheduled wages received and the advanced wages disbursed to the employee during the i) pay period and/or ii) one or more previous pay periods, such that i) if the difference is greater than the desired amount, the available transfer amount equals the desired amount, and ii) if the difference is less than the desired amount, the available transfer amount equals at most the difference.

45. The method of claim 43, further comprising sending an alert to the employee, a system administrator, or both, when the determined available transfer amount is less than the desired amount.

46.-48. (canceled)

49. The method of claim 43, further comprising verifying an employment status of the employee during the pay period, the employment status corresponding to an active status or an inactive status, wherein an active status corresponds a prediction of the employee receiving the next scheduled wages, and an inactive status corresponds to a prediction of the employee not receiving the next scheduled wages.

50. The method of claim 49, wherein verifying the employment status comprises predicting whether the employee will receive a next scheduled wages using a first decision engine, wherein an active status corresponds to an employee receiving the next scheduled wages.

51.-58. (canceled)

59. The method of claim 49, wherein verifying the employment status comprises determining an employee risk level using a second decision engine.

60.-63. (canceled)
